(19) United States
(12) Patent Application Publication
(10) Pub. No.: US 2024/0204277 A1
(43) Pub. Date: Jun. 20, 2024

(54) EXTRACTION OF METALS FROM LITHIUM-ION BATTERY MATERIAL

(71) Applicant: METSO FINLAND OY, Espoo (FI)

(72) Inventors: Tuomas VAN DER MEER, Espoo (FI); Marika TIIHONEN, Espoo (FI); Annukka MAKINEN, Espoo (FI); Niko ISOMAKI, Espoo (FI); Roshan BUDHATHOKI, Espoo (FI)

(73) Assignee: METSO FINLAND OY, Espoo (FI)

(21) Appl. No.: 18/555,203

(22) PCT Filed: Apr. 14, 2021
(86) PCT No.: PCT/FI2021/050270

§ 371 Date: Oct. 12, 2023

(51) Int. Cl. H01M 10/54; B09B 3/40; B09B 3/70; B09B 3/80; B09B 101/16; C01B 25/30; C01D 15/02; C01D 15/08; C01G 51/10; C01G 53/10; C22B 1/02; C22B 3/00; C22B 3/02; C22B 3/08; C22B 3/42; C22B 3/44; C22B 7/00; C22B 21/00; C22B 26/12; C22B 47/00

(52) U.S. Cl. CPC H01M 10/54; B09B 3/40; B09B 3/70; B09B 3/80; C01B 25/30; C01D 15/02; C01D 15/08; C01G 51/10; C01G 53/10; C22B 1/02; C22B 3/02; C22B 3/08; C22B 3/42; C22B 3/44; C22B 7/007; C22B 21/0007; C22B 21/0023; C22B 23/043; C22B 26/12; C22B 47/00; B09B 2101/16

(57) ABSTRACT

A method for extracting metals from the black mass of lithium-ion batteries, the black mass containing the anode and cathode materials of the batteries, and the cathode material including lithium and nickel. An arrangement is provided that is suitable for use in the method.

### BACKGROUND OF THE INVENTION

### Field of the Invention

The present invention relates to a method for extracting metals from lithium-ion battery material, particularly from the black mass obtained from said battery material. Such a black mass contains mainly cathode metals and anode material, and the cathode metals, in turn, typically comprise lithium and nickel, further possible cathode metals being cobalt, manganese and aluminium. The invention also relates to an arrangement that is suitable for use in the method.

### Description of Related Art

The use of lithium-ion batteries has grown steadily for the last years, and their importance appears to grow even further as the development of new electric vehicles continues. Lithium ion batteries contain, in their cathodes, several transition metals that can be valuable when recovered from these batteries, either for reuse in new batteries or for other purposes. Particularly the lithium of these materials should be recovered and reused.

Hydrometallurgical separations of metals from lithium-ion batteries proceed via the recovery of a black mass, which contains cathode metals and anode material, but from which wiring and other coarse solid battery components, such as plastic or steel parts, have already been removed.

The next step in the recovery of the metals, after the formation of the black mass, is typically the separation of the cathode metals from the other components of the black mass, e.g. using mechanical, thermal or chemical pre-treatment steps, followed by acid leaching to solubilize the cathode metals, and prepare them for recovery.

Each step of the overall hydrometallurgical process poses a risk for metal losses, which losses should naturally be reduced. The present inventors have now found a new procedure for reducing lithium losses.

### SUMMARY OF THE INVENTION

The invention is defined by the features of the independent claims. Some specific embodiments are defined in the dependent claims.

According to a first aspect of the present invention, there is provided a method for extracting metals from the black mass obtained from lithium-ion battery material, the black mass containing the anode and cathode materials of the batteries. Particularly, the metals that are extracted include lithium and nickel, and possibly other transition metals, such as cobalt, manganese and aluminium.

According to a second aspect of the invention, there is provided a method aiming at increasing the recovery of lithium.

According to a third aspect of the invention, there is provided a method including one or more steps for recycling lithium-containing fraction(s) to the leaching step, to provide an increased lithium recovery.

According to a further aspect of the invention, there is provided an arrangement suitable for use in carrying out the steps of the method of the invention.

The method of the invention thus comprises
one or more leaching steps,
the metal separation steps required to recover the desired transition metals, typically as fractions including at least lithium and nickel ions, and
one or more steps for recycling lithium-containing fraction(s) to the leaching step.

Likewise, the arrangement of the invention comprises
one or more leaching units, from which a leach solution containing dissolved metal ions is recovered,
metal separation units, for recovering fractions including at least lithium and nickel ions, and
one or more recycle lines for conducting one or more further lithium-containing fractions to the leaching unit(s).

Thus, the invention is related to the recovery of fractions containing minor amounts of lithium, to be combined with the main lithium fraction, thus increasing the yield or recovery of lithium product in the metal separation steps.

The present invention thus provides several advantages. Naturally, an increased lithium yield is achieved. However, the recycling options of the invention also reduce the amount of lithium in the waste effluents, thereby simplifying the waste treatment requirements. Lithium can cause problems in waste treatments, and the present method is capable of decreasing the amount of lithium in the waste effluents to a significant degree.

### BRIEF DESCRIPTION OF THE DRAWINGS

FIG. 1 is a diagram illustrating the units of the arrangement according to the invention.

FIGS. 2A and 2B, as well as FIGS. 3 and 4 are diagrams illustrating the units of arrangements according to embodiments of the invention.

### EMBODIMENTS OF THE INVENTION

### Definitions

In the present context, the term “black mass” is intended to describe the mixture of cathode and anode material that is obtained after a mechanical separation of the components of batteries, the black mass typically also containing organic compounds depending on the black mass pre-treatment method, such as the compounds originating from the electrolytes of the batteries.
“Organic compounds” are herein intended to encompass molecules, where one or more atoms of carbon are covalently linked to one or more atoms of hydrogen, oxygen or nitrogen. Thus, e.g. graphite or other allotropes of pure carbon, are excluded from this group of compounds. Other compounds commonly considered to be excluded from this class of compounds, despite fulfilling the definition, include carbonates and cyanides, if the only carbon of the compound is based in this group, as well as carbon dioxide.
The “anode” is typically formed of e.g. graphite or silicon, which are not solubilized in the leaching of the invention, but are present in the black mass before leaching.
The “cathode material” or “cathode metals”, in turn, encompass metal ions, such as lithium, nickel, cobalt and manganese (Li, Ni, Co and Mn), typically in the form of their oxides. The contents of these metals in the black mass are preferably all within the range of 1-35% by weight. Other examples of cathode components that may be present in the black mass, usually however in smaller amounts, include tin, zirconium, zinc, copper, iron, fluoride, phosphorus and aluminium (i.e. Sn, Zr, Zn, Cu, Fe, F, P and Al).

The present invention relates to a method for extracting metals from the black mass of lithium-ion battery material. The method comprises the following steps:
a) one or more pre-treatment steps, wherein a fraction containing non-metallic material is separated from the black mass, and a pre-treated black mass containing anode and cathode materials is recovered, and preferably treated further by leaching,
b) one or more leaching steps, carried out on a metal-containing leaching feed formed of the pre-treated black mass, combined with recycled lithium precipitate(s), the leaching step(s) including an acid leaching step carried out in a solution containing sulphuric acid, whereby metals of the leaching feed are dissolved, and a leach solution containing the dissolved metals is recovered, and preferably treated further by separating metallic fractions therefrom, and
c) metal separation steps, wherein initial fractions of metallic material are separated from the leach solution and main fractions containing at least nickel and lithium are recovered, whereby a fraction containing lithium is recovered after the recovery of a nickel fraction has taken place, and the recovery of the lithium fraction includes
   i. a step of reacting the lithium into lithium carbonate, followed by
   ii. a separation of the solids from the liquid, whereby
      the lithium-containing solids are recovered as such or reacted into a further lithium product, whereas
      the liquid effluent is reacted with a phosphate reagent, causing precipitation of the lithium remaining therein into a lithium phosphate precipitate, and
      at least a fraction of the obtained lithium precipitate is recycled to the acid leaching step.

The black mass of lithium ion batteries typically contains both cathode and anode materials, as well as electrolyte materials with organic compounds. For the purposes of the invention, the organic compounds are preferably removed from the black mass by the above mentioned pre-treatment step(s). For example, one or more washing steps can be used, preferably carried out by mixing the battery material with water or an organic solvent, most suitably with water, whereby material that is dissolved or dispersed in said solvent, such as said organic compounds, can be separated from the undissolved components of the black mass. Alternatively, one or more heating steps, typically carried out as pyrolysis or evaporation steps, can be used to remove organic compounds, preferably carried out at a temperature of 195-470° C. A further option is to carry out both a washing step and one of the mentioned heating procedures.

The pre-treatment step(s) thus yield a pre-treated black mass that preferably contains the lithium, nickel and cobalt, and possibly manganese, of the battery cathode, in oxide form, and more preferably contains only <3% by weight of remaining organic compounds, most suitably <1.5% by weight.

In a preferred embodiment of the invention, at least a fraction of the lithium typically lost in the optional washing steps is recovered by
a step of reacting the used washing solution, containing the separated fraction of non-metallic material, with a phosphate reagent, to cause precipitation of the lithium therein into lithium phosphate, and
a step of separating the lithium phosphate precipitate from the remaining washing solution and combining it with the pre-treated black mass that is carried to the following leaching step(s).

After the pre-treatment step(s), a solid/liquid separation is typically carried out, whereby the pre-treated black mass can be carried to the following leaching step, and optionally mixed with added metal-containing solids or slurry, such as a lithium phosphate precipitate recycled from either the pre-treatment steps or the metal recovery steps.

In an embodiment of the invention, only one leaching step is used, which is said acid leaching step, carried out in a solution containing sulphuric acid. Typically, the acid leaching is thus carried out by dispersing the pre-treated black mass into a solution containing the acid, and adding the optional extractants, preferably followed by mixing.

The temperature during the leaching step is preferably adjustable, whereby the temperature most suitably is maintained at an elevated level during the acid leaching, such as a temperature of >50° C., preferably a temperature of 50-95° C., and more preferably a temperature of 60-90° C. Similarly, the pressure during the acid leaching is preferably maintained at atmospheric pressure, or slightly elevated pressure of 100-200 kPa. Typically, the solubilisation of the desired transition metals is complete within a time of 2-6 hours.

The sulphuric acid addition is used in part to adjust the pH of the leaching solution. The pH of the leaching solution is thus preferably adjusted to a level of 0-5, more preferably 1-2, using said sulphuric acid, before adding the optional extractants, preferably selected from hydrogen peroxide, a carbohydrate and sulphur dioxide, due to their reductive capabilities, providing a more effective dissolution.

After the leaching reaction is complete, i.e. after the pre-treated black mass has spent a sufficient amount of time, such as 2-6 hours, in the leaching conditions, a solid/liquid separation is typically carried out, in order to recover the leach solution containing the cathode metals, whereby it can be carried to the following step of the method, for recovery of separate metallic fractions.

In an embodiment of the invention, the recovery of main fractions of metallic material including at least nickel and lithium ions is preferably preceded by the one or more steps for separating initial fractions of metallic material from the leach solution. Said initial fractions of metallic material (or “the initial metallic fractions”) typically include at least one of iron, aluminium, calcium and fluoride ions, and possible phosphates. This order of steps has the advantage of providing a purified solution for the recovery of the main fractions of metallic material, since the initial fractions include the materials that are considered to belong to the impurities. These materials would also impair the subsequent recoveries of the main fractions, or at least result in lower purity or lower yields, if left in the leach solution.

Preferably, the step(s) for separating initial fractions of metallic material from the leach solution include the steps for separating two or more of, preferably three or four of, and most suitably all of, iron, aluminium, calcium and fluoride ions. Also copper can be included in these initial fractions. Optionally, a separate copper recovery step can be carried out, preferably before the other initial fraction(s) are separated from the solution.

Typically, the separation(s) of initial fractions of metallic material include at least one step carried out as a solvent extraction (SX), intended to remove said impurities, such as iron and aluminium, from the leach solution, optionally preceded by a solid separation, to remove any impurities already in solid form, thus increasing the selectivity of the solvent extraction

In another alternative, the separation(s) of initial fractions of metallic material include at least one step carried out as a precipitation, for example a hydroxide precipitation, intended to remove impurities, such as iron and aluminium, as a solid fraction from the leach solution. Such a hydroxide precipitation has been shown to be effective also for precipitating phosphates, such as the phosphate of the recycled lithium phosphate obtained from the lithium recovery steps and optionally from the pre-treatment steps.

In a particularly preferred alternative, the separation of initial fractions of metallic material includes a precipitation, with an optional separation of the precipitated impurities, that is followed by a solvent extraction, both steps as described above. The advantage of such a two-step impurity separation is that the contents of impurities, such as iron and aluminium, are further decreased in the thus purified leach solution. It is particularly preferred to carry out the precipitation before the solvent extraction in such a two-step separation of initial metallic fractions, since this will facilitate a high selectivity in the solvent extraction.

In case the copper is separately recovered, this copper recovery step is preferably carried out before said initial fractions of metallic material are separated from the leach solution, since copper can have a negative impact on subsequent recoveries and more importantly product qualities.

Since the acid leaching step has been carried out in an acid solution, the first metal separation step is required to endure acidic conditions. This requirement is fulfilled for the separations of the initial metallic fractions.

Various reactions and procedures can be utilized to carry out said metal separations and recoveries, such as further leaching or washing steps, solvent extractions, precipitations, ion exchange steps, and electrowinning steps. However, for the separations of the initial metallic fractions it is preferred to utilize at least one solvent extraction, since this will result in a higher purity of the remaining solution, thus also facilitating the subsequent recoveries of the main fractions, particularly the recovery of cobalt and nickel, whereby all of the metals of the main fractions can be recovered in high yield and high purity, typically as battery-grade materials.

As mentioned above, the recoveries of the main fractions of metals include steps for recovering at least nickel and lithium ions, and possibly cobalt and manganese, although the recoveries can be carried out in varying order.

Particularly, the recoveries of the main fractions include steps for recovering at least one of, preferably both of manganese and cobalt, in addition to said nickel and lithium ions. Typically, any manganese, cobalt and nickel are recovered before said lithium.

A lithium recovery is thus preferably carried out after the separation of the initial metallic fractions, and more preferably also after any of the manganese, cobalt, and nickel present in the leach solution have been recovered. Using this preferred order of steps will result in a situation, where the lithium can be recovered from a high-purity lithium-containing solution.

The lithium is recovered by reacting the lithium into its carbonate, producing a product fraction that can be recovered as such, or alternatively be further converted into e.g. lithium hydroxide, which can then be crystallized into pure hydroxide crystals.

A further option for the lithium recovery is to use a solvent extraction, after which a further conversion or crystallization can be carried out. The benefit of this procedure is an even higher lithium recovery.

The liquid fraction obtained when reacting the lithium into its carbonate still contains some lithium that may be recovered separately. This liquid fraction is thus reacted further with a phosphate reagent, and possibly a separate precipitation reagent, thus causing precipitation of the lithium remaining therein into a lithium phosphate precipitate, at least a fraction of which, after a separation of the precipitate from the remaining effluent, can be recycled to the leaching step by mixing it with the pre-treated black mass. Also, a fraction of the precipitated lithium phosphate may be directed to the above described steps for lithium recovery, where the phosphate, together with the carbonate, can be reacted into lithium hydroxide.

The phosphate reagent used above can be selected from any phosphates of alkali or earth alkali metals. However, sodium phosphate (Na₃PO₄) is preferred, since it brings no new cations to the reaction mixture, and since it has a suitable reactivity.

The precipitation of the lithium in the lithium-containing liquid fraction, e.g. obtained when reacting the lithium into its carbonate, into lithium phosphate is typically carried out at a temperature of 50-90° C., preferably 70-90° C. The pH, in turn, is typically maintained at 4 or higher, preferably at 7 or higher.

The same conditions and reagents as used here for the liquid fraction obtained when reacting the lithium into its carbonate can be used also for the washing solution obtained from the pre-treatment steps, optionally treated for lithium recovery by precipitation into lithium phosphate.

A nickel recovery is also carried out on the leach solution, preferably after the separation of the initial metallic fractions, typically taking place either simultaneously with or directly after the optional recovery of cobalt, more preferably after the cobalt is recovered, and most suitably before the above mentioned lithium recovery. Similarly, it is preferred to carry out the nickel recovery after an optional manganese recovery.

Said nickel recovery can be carried out, for example using a solvent extraction (SX), which produces a rather pure nickel sulphate solution (NiSO₄). This solution is optionally purified further, e.g. by ion exchange (IX), after which a crystallization can be carried out, or a precipitation into a hydroxide or a carbonate, or the sulphate solution can be used as such, without crystallization or precipitation, e.g. in the preparation of new cathode materials. The optional solvent extraction for nickel recovery is most suitably carried out using extraction chemicals having a carboxylic acid functional group, one commercial example of suitable extraction chemicals being Versatic™ 10, which is a neodecanoic acid.

A cobalt recovery is also preferably carried out on the leach solution after the separation of the initial metallic fractions, typically taking place either simultaneously with or directly before the recovery of nickel, more preferably before the nickel is recovered, and most suitably also before the lithium is recovered. Similarly, it is preferred to carry out the cobalt recovery after an optional manganese recovery.

A preferred option for said cobalt recovery is a solvent extraction (SX), which produces a rather pure cobalt sulphate solution (CoSO₄). This solution is optionally purified further, e.g. by ion exchange (IX), after which a crystallization can be carried out, or a precipitation into a hydroxide or a carbonate, or the sulphate solution can be used as such, without crystallization or precipitation, e.g. in the preparation of new cathode materials. The optional solvent extraction for cobalt recovery is most suitably carried out using extraction chemicals having a carboxylic acid functional group, such as the phosphinic acid functional group, one example of suitable extraction chemicals being Cyanex™ 272, which is also known as trihexyltetradecylphosphonium bis(2,4,4-trimethylpentyl)phosphinate.

In one alternative manner of proceeding with the metal separation steps, as indicated above, cobalt and nickel can be recovered simultaneously from the leach solution, for example by a solvent extraction, thus producing a sulphate solution, optionally followed by a further purification by ion exchange (IX), or a precipitation into the hydroxides or the carbonates. Alternatively, the sulphate solution can be used as such, without crystallization or precipitation, e.g. in the preparation of new cathode materials.

According to an embodiment of the invention, the metal separation steps include a step for recovering manganese from the leach solution, the manganese recovery also carried out after the separation of the initial metallic fractions. Preferably, the manganese is recovered before the recovery of nickel or the optional recovery of cobalt, and most suitably before any of the nickel, cobalt or lithium are recovered.

Options for said manganese recovery include solvent extractions, precipitations and crystallizations, or a solvent extraction followed by a precipitation or crystallization. One particularly preferred option is to utilize an oxidative precipitation using sulphur dioxide, SO₂, and air, to form the manganese oxide, MnO₂.

The method of the invention can be carried out in any suitable apparatus or arrangement, with the units and equipment needed to carry out the steps of the method.

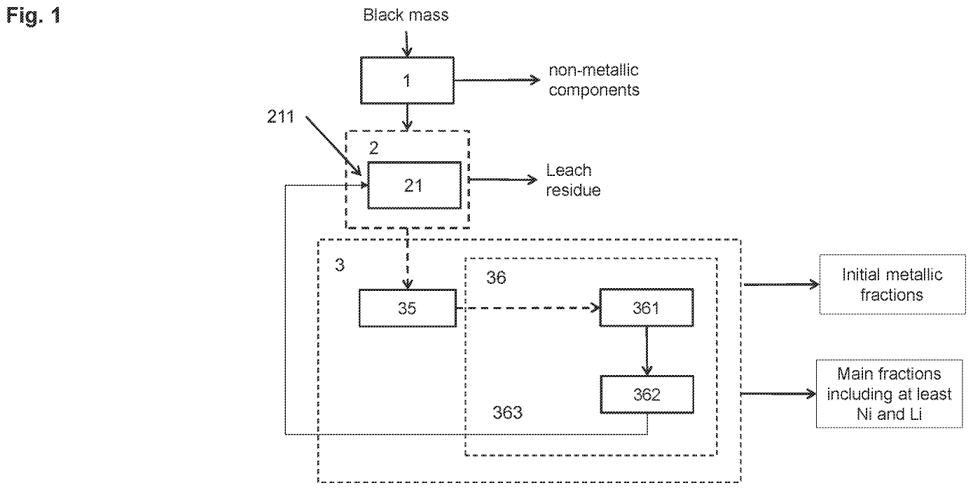

In one embodiment of the invention, the method described above is carried out using the arrangement of FIG. 1, which comprises the following units:
one or more pre-treatment units 1 for separating a fraction containing non-metallic components from the black mass, and recovering a pre-treated black mass containing the anode and cathode materials, preferably intended to be conducted via suitable connections to a downstream leaching unit 2,
one or more leaching units 2, for dissolving metals of the pre-treated black mass, combined with recycled lithium precipitate(s), and recovering a leach solution containing said dissolved metals, preferably intended to be conducted via suitable connections to a downstream separation unit 3, at least one leaching unit 2 being in the form of an acid leaching unit 21, with inlets 211 for sulphuric acid and possible extractants, and
metal separation units 3 for separating initial fractions of metallic material from the leach solution and for recovering main fractions containing at least nickel and lithium as product fractions, whereby a lithium recovery unit 36 is positioned downstream from a nickel recovery unit 35, and the lithium recovery unit 36 includes the following subunits:
   a unit 361 for reacting the lithium into solid lithium carbonate, from which a liquid effluent can be separated and carried further to
   a reaction unit 362 for reacting the liquid effluent with a phosphate reagent, thus causing precipitation of the lithium remaining therein into a lithium phosphate precipitate, which can be separated from the remaining effluent and carried further via
   a recycle line 363 to the acid leaching unit 2, in order to recover at least a fraction of the thus obtained lithium precipitate.

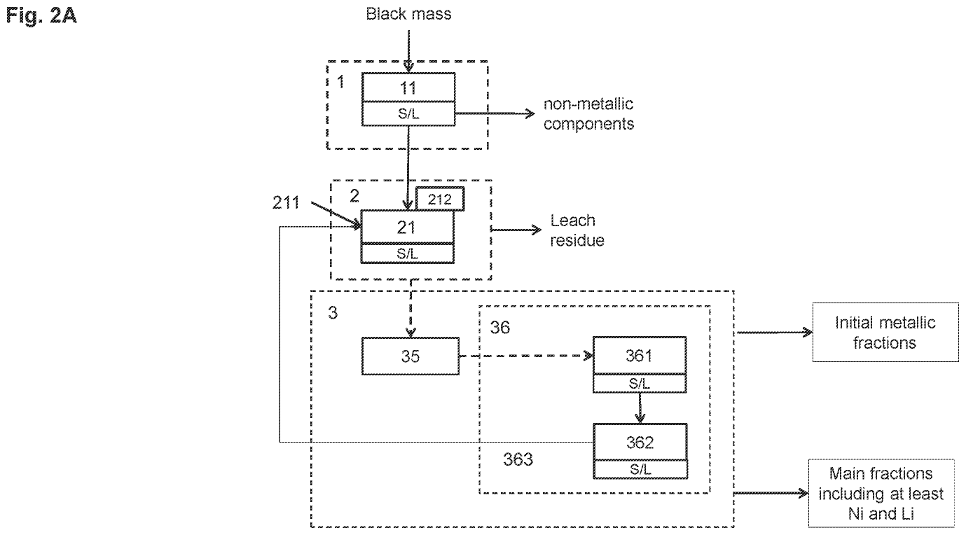

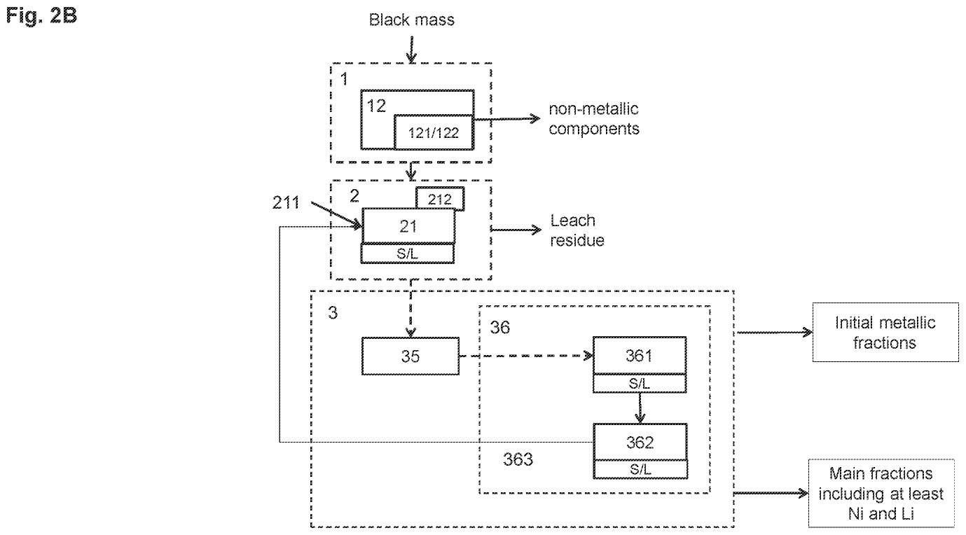

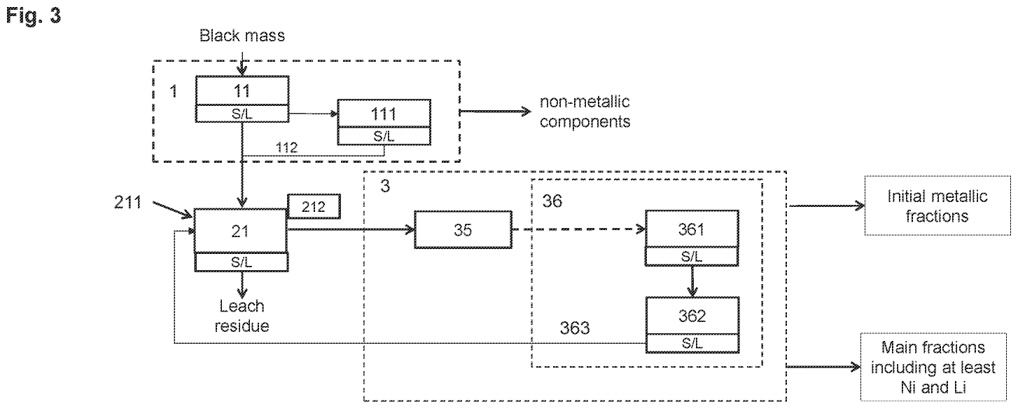

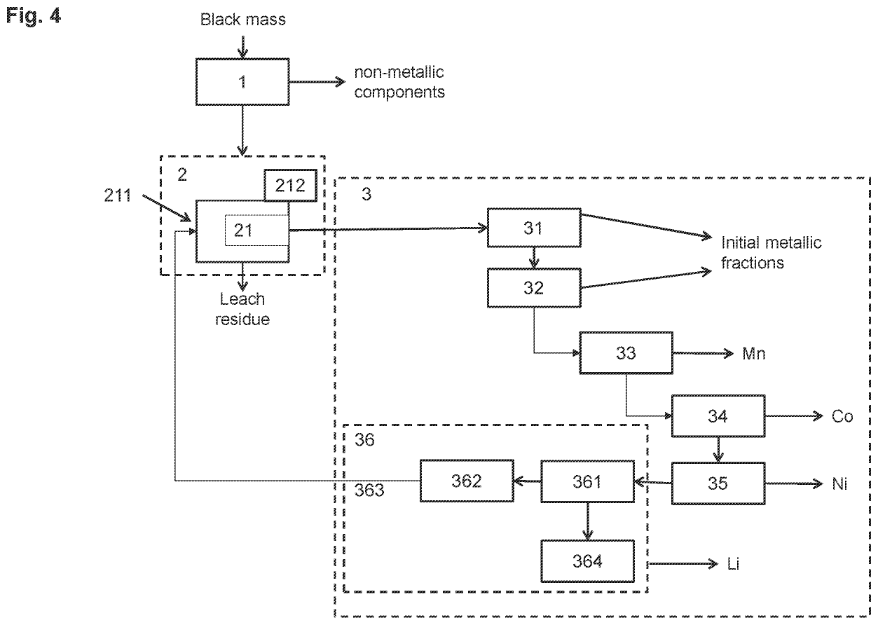

In an embodiment of the invention, with various options illustrated in FIGS. 2A and 2B, the pre-treatment unit(s) 1 include a washing unit 11 or a heating unit 12, or both, for removing non-metallic components, such as organic compounds, from the black mass, the heating unit 12 most suitably selected from a pyrolysis unit 121 or an evaporation unit 122. The optional washing unit 11 is preferably further equipped with a water inlet.

In a preferred embodiment of the invention, as illustrated in FIG. 3, the pre-treatment unit(s) 1 include at least a washing unit 11, for separating a fraction of non-metallic material from the black mass into a washing solution, typically equipped with a separation subunit for separating the formed lithium precipitate from the remaining solution, and said washing unit 11 is followed by:
a reaction unit 111 for reacting the used washing solution, containing the separated fraction of non-metallic material, with a phosphate reagent, to cause precipitation of the lithium therein into lithium phosphate, typically equipped with a separation subunit for separating the formed lithium precipitate from the remaining solution, and
a recycle line 112 for carrying the obtained lithium phosphate precipitate to the leaching unit 2, to be combined with the pre-treated black mass.

The leaching unit(s) 2 typically consist of only said acid leaching unit(s) 21, which in turn is preferably equipped with the required inlets 211 for sulphuric acid and extractants, as well as means 212 for adjusting the temperature, which can incorporate either heating or cooling, as shown in FIGS. 2-4.

The metal separation units 3 preferably include several subunits, all subunits typically equipped with the further subunits e.g. solvent extraction units, ion exchange units, precipitation units, electrowinning units, washing units or solid/liquid separation units), recycle lines, inlets and outlets needed to carry out the reactions they are intended for.

Preferably, the metal separation unit 3 includes, in addition to the unit 35 for recovering nickel and the unit 36 for recovering lithium, one or more further units 33,34 for recovering manganese and cobalt ions, as illustrated in FIG. 4. All these units for recovering main fractions are preferably preceded by one or more units 31,32 for separating initial fractions of metallic material from the leach solution, these units 31,32 most suitably including at least one solvent extraction unit.

In case copper is separately recovered in the arrangement, the copper recovery unit 31 is preferably placed upstream from the other unit(s) 32 for separating initial metallic fractions from the leach solution.

Various types of units and equipment can be utilized to carry out said separations and recoveries, such as further leaching or washing units, solvent extraction units, precipitation units, ion exchange units, and electrowinning units. However, solvent extraction units are preferred. Particularly, it is preferred to utilize at least one solvent extraction unit for the separations of the initial metallic fractions. More preferably, the solvent extraction is preceded by a solid separation unit, which, in turn, optionally is preceded by a precipitation unit for such impurities.

The units 33,34,35,36 for recovering the main fractions of metallic material thus include units for recovering at least nickel and lithium ions, and can typically be placed in any suitable order, with nickel recovered before lithium.

In a preferred embodiment of the invention, any unit(s) 34,35 for recovering cobalt and nickel are positioned upstream from the unit 36 for recovering lithium.

In another preferred embodiment of the invention, a unit 33 for recovering manganese is included in the arrangement, and is positioned upstream from any units 34,35,36 for recovering cobalt, nickel and lithium.

In one alternative manner of selecting and positioning the metal separation units 3, the cobalt and the nickel can be recovered in the same unit 34/35.

As mentioned above, the lithium recovery unit 36 includes subunits, such as
a unit 361 for reacting the lithium into lithium carbonate, typically followed by a solid/liquid separation subunit for separating the carbonate-containing solids from the liquid effluent,
a reaction unit 362 for reacting the liquid effluent with a phosphate reagent and possibly a separate precipitation reagent, thus causing precipitation of the lithium remaining therein into a lithium phosphate precipitate, typically followed by a solid/liquid separation subunit for separating the lithium precipitate from the remaining liquid effluent, and
a recycle line 363 for recycling at least a fraction of the thus obtained lithium precipitate to the acid leaching unit 2.

Further, as shown in FIG. 4, the lithium recovery unit 36 may contain also a subunit 364 for reacting the lithium-containing solids, obtained after reacting the lithium into lithium carbonate, into lithium hydroxide, which in turn can be crystallized to obtain lithium hydroxide crystals. Also a fraction of the precipitated lithium phosphate may be directed to said reacting subunit 364, to be reacted into lithium hydroxide.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. In addition, various embodiments and examples of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention.

The following non-limiting example is intended merely to illustrate the advantages obtained with the embodiments of the present invention.

### Example—Leaching of Precipitated Lithium Phosphate, Li₃PO₄

30.5 g of a lithium phosphate, Li₃PO₄, containing solid sample with the composition of 15.4% Li and 22.1% of P was leached at a temperature of 80° C. in an agitated reactor. The lithium phosphate was pulped in 0.9 L of 80 g/L sulfuric acid solution and agitated for 2 h.

The leach solution was analysed and contained 5140 mg/L Li and 7540 mg/L P at pH 1.1. The calculated leaching yield for lithium was 98.5%, as shown in the following Table 1.

TABLE 1
Results of analysis of leach solution

| | | |
|---|---|---|
| Volume of test | 0.9 | L |
| Total solids | 30.5 | g |
| Lithium in feed | 4.7 | g |
| Lithium in solution | 4.6 | g |
| Yield | 98.5 | % |

In the following step, the lithium phosphate was precipitated. 1.4 L of the above black mass leach solution at 40° C. was placed to an agitated reactor, followed by step wise addition of 500 g/L NaOH containing solution to increase the pH from 3 to 5 and remove phosphate, iron and aluminium. Efficient removal of phosphate was observed, as shown by the decreased phosphate contents of the solution in the following Table 2.

TABLE 2
Results of analysis of solution during pH increase

| | Total | P | Fe | Al |
|---|---|---|---|---|
| pH | volume [L] | [mg/L] | [mg/L] | [mg/L] |
| 3 | 1472 | 468 | 1820 | 8520 |
| 4 | 1626 | 52 | 118 | 1860 |
| 5 | 1746 | 11 | <5 | 110 |

### INDUSTRIAL APPLICABILITY

The present method, and the arrangement suitable for use in said method, can be used to replace conventional alternatives for recovery of metals from the black mass obtained from lithium-ion batteries.

In particular, the present method and arrangement provides an economical and efficient procedure for recovering at least nickel and lithium, as well as optionally cobalt and manganese, in good yields from such battery material. The yield of lithium is further increased by recovering and recycling the lithium obtained from one or more waste effluents of the method.

### REFERENCE SIGNS LIST

As shown in the FIGS. 1-4, the following units can be included in the arrangement of the present invention, according to one or more embodiments of the invention:
1 Pre-treatment unit, including or consisting of:
   11 Washing unit, typically with a solid/liquid separation subunit, optionally followed by:
      111 reaction unit, typically equipped with a solid/liquid separation subunit, and
      112 recycle line
   12 Heating unit, e.g. in the form of:
      121 unit for pyrolysis
      122 unit for evaporation
2 Leaching unit, typically with a solid/liquid separation unit, the leaching unit including or consisting of:
   21 Acid leaching unit, including:
      211 Inlets for acid and possible extractants
      212 Means for adjusting the temperature
3 Metal separation units, including:
   31 Optional unit for recovering metallic material
   32 Unit for separating initial fraction(s) of metallic material
   33 Optional unit for recovering manganese
   34 Optional unit for recovering cobalt
   35 Unit for recovering nickel
   36 Unit for recovering lithium, including:
      361 unit for reacting lithium into lithium carbonate, typically equipped with a solid/liquid separation subunit
      362 unit for reacting effluent with a phosphate reagent, typically equipped with a solid/liquid separation subunit
      363 recycle line
      364 optional unit for reacting lithium carbonate into its hydroxide

1. A method for extracting metals from the black mass of lithium-ion batteries, the black mass containing the anode and cathode materials of the batteries, and the cathode material comprising lithium and nickel, the method comprising the following steps:
a) one or more pre-treatment steps, wherein a fraction containing non-metallic material is separated from the black mass, and a pre-treated black mass containing anode and cathode materials is recovered,
b) one or more leaching steps, carried out on a metal-containing leaching feed formed of the pre-treated black mass, combined with recycled lithium precipitate(s), the leaching step(s) including an acid leaching step carried out in a solution containing sulphuric acid, whereby metals of the leaching feed are dissolved, and a leach solution containing the dissolved metals is recovered, and
c) metal separation steps, wherein initial fractions of metallic material are separated from the leach solution and main fractions containing at least nickel and lithium are recovered, whereby a fraction containing lithium is recovered after the recovery of a nickel fraction has taken place, and the recovery of the lithium fraction includes
i. a step of reacting the lithium into lithium carbonate, followed by
ii. a separation of the solids from the liquid, whereby
the lithium-containing solids are recovered as such or reacted into a further lithium product, whereas
the liquid effluent is reacted with a phosphate reagent, causing precipitation of the lithium remaining therein into a lithium phosphate precipitate, and
at least a fraction of the obtained lithium precipitate is recycled to the acid leaching step.

2. The method according to claim 1, which is used to extract metals from black mass, wherein the cathode material comprises the lithium and nickel, and preferably also one or more of cobalt, manganese and aluminium, in oxide form.

3. The method according to claim 1, wherein the pre-treatment step(s) include one or more steps of washing or heating, or both, the heating preferably carried out to provide a pyrolysis or an evaporation.

4. The method according to claim 1, wherein the pre-treatment step(s) are carried out to cause separation of non-metallic components, such as organic compounds, from the black mass, thus resulting in a pre-treated black mass containing <3% by weight of organic compounds, preferably <1.5% by weight.

5. The method according to claim 1, wherein the pre-treatment step(s) include
a step of washing the black mass with an aqueous solution or an organic solvent, preferably with an aqueous solution, in order to separate a fraction of non-metallic material from the black mass with the washing solution,
a step of reacting the used washing solution, containing the separated fraction of non-metallic material, with a phosphate reagent, to cause precipitation of the lithium therein into lithium phosphate, and
a step of separating the lithium phosphate precipitate from the remaining washing solution and combining it with the pre-treated black mass that is carried to the leaching step(s).

6. The method according to claim 1, wherein the acid leaching is carried out in a single step by dispersing the pre-treated black mass, mixed with recycled lithium precipitate(s), into a solution containing the acid and optional extractants.

7. The method according to claim 1, wherein the steps for recovering main fractions of metallic material are preceded by the steps for separating initial fractions of metallic material from the leach solution.

8. The method according to claim 1, wherein the steps for separating initial fractions of metallic material from the leach solution are carried out so that said initial fractions include phosphate ions as well as at least one of iron, aluminium, calcium and fluoride ions, preferably including two or more of, more preferably three or four of, and most suitably all of, iron, aluminium, calcium and fluoride ions.

9. The method according to claim 1, wherein at least one of the steps for separating initial fractions of metallic material from the leach solution is carried out as a solvent extraction, intended to remove impurities, such as iron and aluminium, from the leach solution, optionally preceded by a solid separation, to remove any solid impurities and increase the selectivity of the solvent extraction, which solid separation in turn is optionally preceded by a precipitation of such impurities.

10. The method according to claim 1, wherein at least one of the steps for separating initial fractions of metallic material from the leach solution is a precipitation, intended to remove impurities, such as iron and aluminium, as well as phosphates, from the leach solution, preferably followed by a solvent extraction.

11. The method according to claim 1, wherein the metal separation steps include one step for recovering copper from the leach solution, preferably carried out before any other separations or recoveries of metallic material.

12. The method according to claim 1, wherein the recoveries of the main fractions of metallic material include steps for recovering, in addition to nickel and lithium, at least one of manganese and cobalt, preferably for recovering both manganese and cobalt.

13. The method according to claim 1, wherein any steps for recovering manganese, cobalt or nickel are carried out before the recovery of lithium.

14. The method according to claim 1, wherein the lithium-containing solids, obtained after reacting the lithium into a lithium carbonate product, are reacted further into the lithium hydroxide, which in turn can be crystallized to obtain lithium hydroxide crystals.

15. The method according to claim 1, wherein the nickel is recovered simultaneously with cobalt, or separately, preferably separately.

16. The method according to claim 1, wherein the nickel is recovered after the initial fractions of metallic material have been separated from the leach solution, these initial fractions containing also the phosphate of the lithium precipitate recycled to the leaching step.

17. The method according to claim 1, wherein the nickel is recovered by solvent extraction, which produces a nickel sulphate solution (NiSO₄), preferably using extraction chemicals having a carboxylic acid functional group, one commercial example of suitable extraction chemicals being Versatic™ 10, which is a neodecanoic acid.

18. The method according to claim 1, wherein the nickel is recovered by solvent extraction that produces a nickel sulphate solution, which solution is utilized as such, or it is purified further, e.g. by ion exchange and optionally a crystallization, or it is precipitated into a hydroxide or a carbonate.

19. The method according to claim 1, wherein the metal separation steps include a step for recovering cobalt from the leach solution, the cobalt recovery taking place either simultaneously with or directly before the recovery of nickel, preferably directly before the recovery of nickel.

20. The method according to claim 1, wherein the metal separation steps include a step for recovering cobalt from the leach solution, the cobalt recovery taking place by solvent extraction, which produces a cobalt sulphate solution (CoSO₄), preferably using extraction chemicals having a carboxylic acid functional group, such as the phosphinic acid functional group, one example of suitable extraction chemicals being Cyanex™ 272, which is also known as trihexyltetradecylphosphonium bis(2,4,4-trimethylpentyl)phosphinate.

21. The method according to claim 1, wherein the metal separation steps include a step for recovering cobalt from the leach solution, the cobalt recovery taking place by solvent extraction that produces a cobalt sulphate solution, which solution is utilized as such, or it is purified further, e.g. by ion exchange and optionally a crystallization, or it is precipitated into a hydroxide or a carbonate.

22. The method according to claim 1, wherein the metal separation steps include a step for recovering manganese from the leach solution, preferably carried out before the nickel or the cobalt is recovered, more preferably before any of the cobalt, nickel or lithium is recovered, the manganese recovery carried out e.g. by solvent extraction or precipitation, or by a solvent extraction followed by a precipitation.

23. The method according to claim 1, wherein the phosphate reagent used for precipitating the lithium phosphate is selected from any phosphates of alkali or earth alkali metals, preferably being sodium phosphate (Na₃PO₄).

24. The method according to claim 1, wherein the phosphate precipitation is carried out at a temperature of 50-90° C., preferably 70-90° C.

25. The method according to claim 1, wherein the phosphate precipitation is carried out at a pH of 4 or higher.

26. An arrangement for extracting metals from the black mass of lithium-ion batteries, the black mass containing the anode and cathode materials of the batteries, wherein the cathode material comprises lithium and nickel, the arrangement comprising:
one or more pre-treatment units for separating a fraction containing non-metallic components from the black mass, and recovering a pre-treated black mass containing the anode and cathode materials,
one or more leaching units, for dissolving metals of the pre-treated black mass, combined with recycled lithium precipitate(s), and recovering a leach solution containing said dissolved metals, at least one leaching unit being in the form of an acid leaching unit, with inlets for sulphuric acid and possible extractants, and
metal separation units for separating initial fractions of metallic material from the leach solution and for recovering main fractions containing at least nickel and lithium, whereby a lithium recovery unit is positioned downstream from a nickel recovery unit, and the lithium recovery unit includes the following subunits:
a unit for reacting the lithium into solid lithium carbonate, from which a liquid effluent can be separated and carried further to
a reaction unit for reacting the liquid effluent with a phosphate reagent, thus causing precipitation of the lithium remaining therein into a lithium phosphate precipitate, which can be separated from the remaining effluent and carried further via
a recycle line to the acid leaching unit, in order to recover at least a fraction of the thus obtained lithium precipitate.

27. The arrangement according to claim 26, wherein the pre-treatment unit(s) include a washing or a heating unit, or both, for removing non-metallic components, such as organic compounds, from the black mass, the heating unit preferably selected from a pyrolysis unit or an evaporation unit.

28. The arrangement according to claim 26, wherein the pre-treatment unit(s) include
a washing unit for separating a fraction of non-metallic material from the black mass into a washing solution, typically equipped with a separation subunit for separating the formed lithium precipitate from the remaining solution
a reaction unit for reacting the used washing solution, containing the separated fraction of non-metallic material, with a phosphate reagent, to cause precipitation of the lithium therein into lithium phosphate, typically equipped with a separation subunit for separating the formed lithium precipitate from the remaining solution, and
a recycle line for carrying the obtained lithium phosphate precipitate to the leaching unit, to be combined with the pre-treated black mass.

29. The arrangement according to claim 26, wherein the leaching unit(s), preferably at least the acid leaching unit is equipped with means for adjusting the temperature.

30. The arrangement according to claim 26, wherein the metal separation units include one or more units for recovering main fractions of metallic material, including at least a unit for recovering nickel and a unit for recovering lithium ions, preceded by one or more upstream units for separating initial metallic fractions from the leach solution, the initial fractions including phosphate ions as well as at least one of iron, aluminium, calcium and fluoride ions.

31. The arrangement according to claim 26, wherein the lithium recovery unit includes a subunit E for reacting the lithium-containing solids, obtained after reacting the lithium into lithium carbonate into lithium hydroxide, which in turn can be crystallized to obtain lithium hydroxide crystals.

32. The method according to claim 1, which is carried out using the arrangement of claim 26.
